(19) United States
(12) Patent Application Publication
(10) Pub. No.: US 2021/0218851 A1
(43) Pub. Date: Jul. 15, 2021

(54) COMMUNICATION PROFILES

(71) Applicant: Hewlett-Packard Development Company, L.P., Spring, TX (US)

(72) Inventors: Joel Fyan, Boise, ID (US); Mark A Fahrenkrug, Waukee, IA (US); Dennis W Howard, Boise, ID (US); Yasmin Sahaf, Boise, ID (US)

(73) Assignee: Hewlett-Packard Development Company, L.P., Spring, TX (US)

(21) Appl. No.: 17/257,035

(22) PCT Filed: Sep. 27, 2018
(86) PCT No.: PCT/US2018/053032

§ 371 Date: Dec. 30, 2020

(51) Int. Cl. H04N 1/00; H04L 29/08; H04L 12/26

(52) U.S. Cl. CPC H04N 1/00074; H04N 1/0001; H04L 43/0817; H04L 67/303; H04N 1/00087

(57) ABSTRACT

Examples dis closed herein relate to receiving a first sta tus update from a device according to a communication profile, determining whether a communication problem occurred from the device, and in response to determining that the communication problem occurred from the first device, updating the communication profile for the first device and receiving a second status update from the device according to the updated communication profile.

### BACKGROUND

Various devices often communicate with services and each other to share information, such as error conditions, current status, and the like. Such device communications may rely on a variety of protocols and parameters that may vary from device to device.

### BRIEF DESCRIPTION OF THE DRAWINGS

FIG. 1 is an example environment for providing communication profiles.

FIG. 2 is a block diagram of an example computing device for providing communication profiles.

FIG. 3 is a block diagram of an example system for providing communication profiles.

FIG. 4 is a flowchart of an example method for providing communication profiles.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations consistent with the description; however, the description is not limited to the examples and/or mplementations provided in the drawings.

### DETAILED DESCRIPTION

Most multi-function-print devices (MFPs) provide several features, such as an option to scan a physical document, which may be controlled via an on-device control panel, a connected application, and/or a remote service. Other options may include printing, copying, faxing, document assembly, etc. The scanning portion of an MFP may comprise an optical assembly located within a sealed enclosure. The sealed enclosure may have a scan window through which the optical assembly can scan a document, which may be placed on a flatbed and/or delivered by a sheet feeder mechanism.

These MFPs as well as other devices may need to communicate with each other and/or with other services, such as device management services, document delivery services, mobile apps, network or web-based applications, and the like. Many implementations rely on relatively static mechanisms for communicating with these devices. For each network protocol (e.g., HTTP, SNMP), these solutions start with default communication parameters that may then be adjusted in the context of a single attempt as requests fail. Such algorithms are often simplistic, using things like increases in timeouts in an attempt to successfully communicate on some set number of retries. Often, these solutions do not remember how the communication was adjusted after a communication session completes, and each subsequent communication must repeat the same algorithm and will likely meet with the same result.

Improved communication for these devices may not just tune individual parameters but take larger context or historical data into consideration for subsequent communications. For example, a device that adjusts several parameters from the default communication profile may start with the adjusted parameters for a subsequent communication attempts. Furthermore, different profiles may be learned that perform better in different circumstances, such as at particular times, under load, and/or for different types of data, and those profiles may be remembered and re-used when those circumstances reoccur,

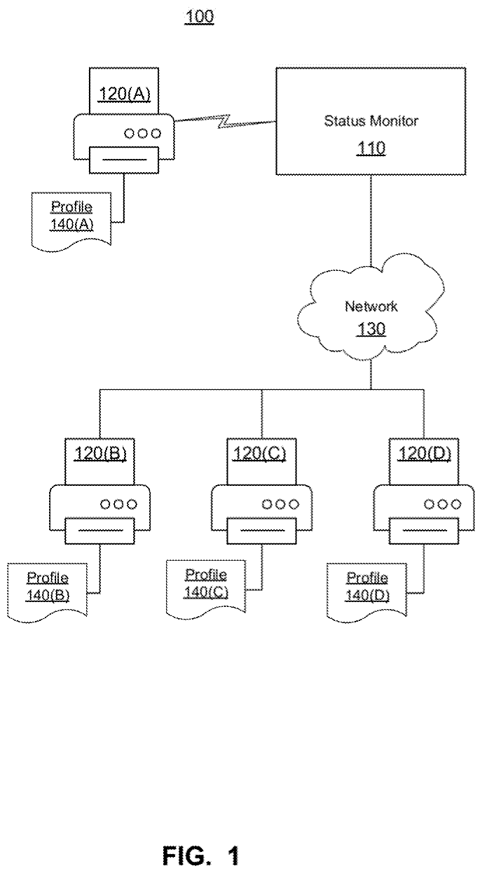

FIG. 1 is an example environment 100 for providing communication profiles. Environment 100 may comprise a status monitor 110 in communication with a plurality of devices 120(A)-(D), such as printers, computers, multi-function devices, etc. For example, status monitor 110 may comprise a computer such as a server, desktop, laptop, notebook, tablet, smartphone, etc. Status monitor 110 may communicate, for example, with device 120(A) via a direct wired and/or wireless connection, such as ethernet, Bluetooth, WiFi, etc. Similarly, status monitor 110 may communicate with devices 120(B)-(D) through a network 130 such as local area network, wide area network, wireless network, the Internet, etc. Network 130 may comprise a plurality of components (not shown) such as routers, switches, antennas, firewalls, etc.

In some implementations, device 120(A)-(D) may provide status reports to status monitor 110 and/or receive data from status monitor 110. For example, device 120(B) may report that it is out of paper to status monitor 110. For another example, device 120(C) may receive a print job for processing from status monitor 110. Numerous other types of data may be exchanged between devices 120(A)-(D) and status monitor 110. Each of devices 120(A)-(D) may be associated with a respective communication profile 140(A)-(D) used for communicating with status monitor 110 and/or amongst each other. In various implementations, profiles 140(A)-(D) may be generated and/or updated by devices 120(A)-(D) and/or by status monitor 110 as described in detail below.

Communication profiles 140(A)-(D) may comprise various parameters associated with creating a communicative coupling between two devices, such as between device 120(A) and status monitor 110 and/or between device 120(A) and device 120(B). Such parameters may comprise details such as when the profile 140(A)-(D) is to be used, with which device(s) it should be used, and/or for what data it should be used. Profiles 140(A)-(D) may further comprise parameters specific to the communicative coupling, such as which network (e.g., wired, wireless, Bluetooth, cellular, near-field communication (NFC), etc.), which communication protocol (e.g., internet protocol (IP), simple network management protocol (SNIP), hypertext transfer protocol (HTTP), etc.), as well as protocol and/or network specific parameters such as domain name servers (DNS) or dynamic host configuration protocol (DHCP) servers to use, timeout lengths, retry counts, packet sizes, credentials and/or certificate information, port numbers, etc. In some implementations, communication profiles 140(A)-(D) may comprise historical communication information such as which profile settings resulted in successful and/or unsuccessful couplings between the respective devices. For example, a communication profile may record communication attempts using a 10ms timeout length that resulted in data errors from packet loss, while communication couplings using a 20ms timeout length did not result in such errors.

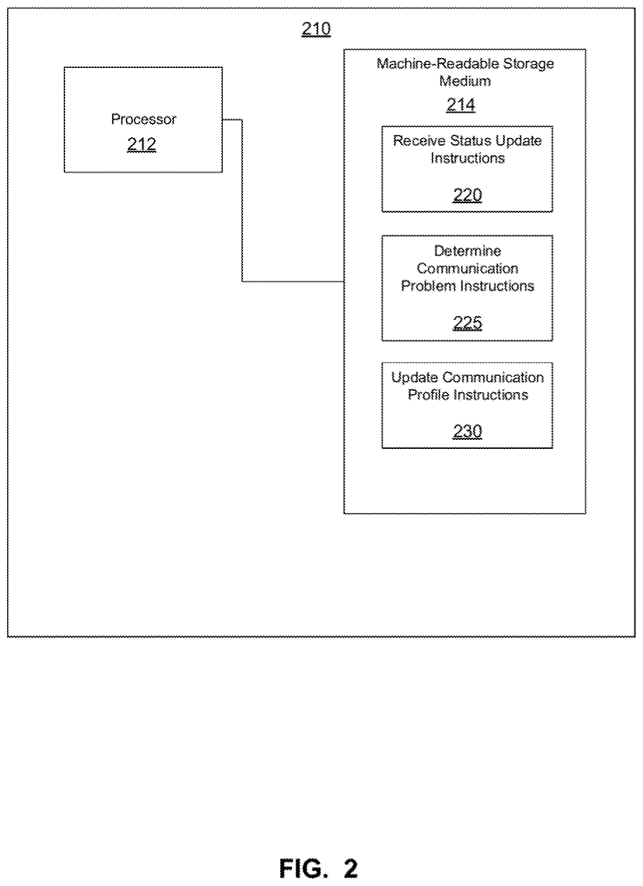

FIG. 2 is a block diagram of an example computing device 210 for providing communication profiles. Computing device 210 may comprise a processor 212 and a non-transitory, machine-readable storage medium 214. Storage medium 214 may comprise a plurality of processor-executable instructions, such as receive status update instructions 120, determine communication problem instructions 225, and update communication profile instructions 230. In some implementations, instructions 220, 225, 230 may be associated with a single computing device 210 and/or may be communicatively coupled among different computing devices such as via a direct connection, bus, or network.

Processor 212 may comprise a central processing unit (CPU), a semiconductor-based microprocessor, a programmable component such as a complex programmable logic device (CPLD) and/or field-programmable gate array (FPGA), or any other hardware device suitable for retrieval and execution of instructions stored in machine-readable storage medium 214. In particular, processor 212 may fetch, decode, and execute instructions 220, 225, 230.

Executable instructions 220, 225, 230 may comprise logic stored in any portion and/or component of machine-readable storage medium 214 and executable by processor 212. The machine-readable storage medium 214 may comprise both volatile and/or nonvolatile memory and data storage components. Volatile components are those that do not retain data values upon loss of power. Nonvolatile components are those that retain data upon a loss of power.

The machine-readable storage medium 214 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, and/or a combination of any two and/or more of these memory components. In addition, the RAM may comprise, for example, static random access memory (SRAM), dynamic random access memory (DRAM), and/or magnetic random access memory (MRAM) and other such devices. The ROM may comprise, for example, a programmable read-only memory (PROM), an erasable programmable read-only memory (EPROM), an electrically erasable programmable read-only memory (EEPROM), and/or other like memory device,

Receive status update instructions 220 may receive a first status update, from a device according to a communication profile and/or receive a second status update from the device according to an updated communication profile. For example, device 120(A) may provide a daily status report to status monitor 110 executing receive status update instructions 220. The status report may comprise, for device 120(A) comprising a printing device, statistics such as pages printed, users who accessed device 120(A), supply levels, errors that occurred, etc. In some implementations, the status report may be requested by device 210 and/or may be provided by the reporting device (e.g., device 120(A)) on an occasional and/or periodic basis.

In some implementations, the first status update and the second status update may each comprise a device identifier. For example, device 120(A) and device 120(B) may each provide status reports to status monitor 110 comprising unique device identifiers. This may enable status monitor 110 to keep track of different events affecting the different devices and/or prepare and provide a report about the different devices, such as via a device management application's user interface.

The communication profile may comprise a plurality of parameters associated with a network-based communication, such as a communication interval, a communication protocol, and/or a domain name service (DNS) parameter. Such parameters may comprise details such as when the profile 140(A)-(D) is to be used, with which device(s) it should be used, and/or for what data it should be used. Profiles 140(A)-(D) may further comprise parameters specific to the communicative coupling, such as which network (e.g., wired, wireless, Bluetooth, cellular, near-field communication (NFC), etc.), which communication protocol (e.g., internet protocol (IP), simple network management protocol (SNMP), hypertext transfer protocol (HTTP), etc.) as well as protocol and/or network specific parameters such as domain name servers (DNS) or dynamic host configuration protocol (DHCP) servers to use, timeout lengths, retry counts, packet sizes, credentials and/or certificate information, port numbers, etc. In some implementations, communication profiles 140(A)-(D) may comprise historical communication information such as which profile settings resulted in successful and/or unsuccessful couplings between the respective devices.

In some implementations, receive status update instructions 220 may comprise instructions to receive a plurality of respective status updates from a plurality of devices. For example, computing device 210 may request a current status from each of devices 120(A)-(D) either as status monitor 110 and/or on behalf of status monitor 110. Each of the plurality of devices 120(A)-(D) may be associated with a respective communication profile (e.g., profiles 140(A)-(D)).

Determine communication problem instructions 225 may determine whether a communication problem occurred from the device. For example, a communication between device 120(A) and status monitor 110 may comprise data errors, such as may be caused by dropped packets. For another example, device 210 may, acting as status monitor 110, request a status update from device 120(A) that is never received.

Update communication profile instructions 230 may, in response to determining that the communication problem occurred from the first device, update the communication profile for the first device. in some implementations, the first device (e.g., device 120(A)) may determine that the communication problem occurred, trying to communicate with status monitor 110. Device 120(A) may begin attempting to adjust communication parameters to achieve a successful communication. For example, different protocols (e.g., SNMP vs HTTP) may be tried, different commands within the protocol (e.g., HTTP PUT instead of HTTP POST commands) may be tried, different port numbers may be attempted, and/or different packet sizes and/or different retry attempt counts may be tried.

In some implementations, suggested parameters may be provided by status monitor 110 and/or device 210. In some implementations, the communicating device may examine previous communication attempts and try parameters that have worked in the past. For example, device 120(A) may attempt to provide a status report to device 210 at 9:00 am and fail. Device 120(A) may examine the communication profile 140(A) and determine that only communications occurring between 5:00 pm and 7:00 am have been successful. Device 120(A) may then update communication profile 140(A) to only attempt communication between those times, and retry the communication to provide the status report later during that time window.

In some implementations, update communication profile instructions 230 may comprise instructions to provide the updated communication profile to the device. For example, status monitor 110 may determine that SNMP responses result in a faster status update from device 120(B) than responses provided via HTTP. Respective communication profile 140(B) for device 120(B) may then be updated to communicate with status monitor 110 via SNMP for future status updates. Such an update may be in the form of a new and/or updated profile received from status monitor 110 and/or in the form of instructions from status monitor 110 for device 120(B) to perform the updates to communication profile 140(B). In some implementations, devices may share a communication profile. For example, devices 120(B)-(D) may be located on the same network, and may exchange details about their respective communication profiles 140(B)-(D). For example, device 120(B) may determine that an alternate DNS server provides needed information after a primary DNS server becomes unavailable. Device 120(B) may propagate its communication profile 140(B) to the other devices 120(C)-(D) on the same network to enable those devices 120(C)-(D) to update their respective communication profiles 140(C)-(D).

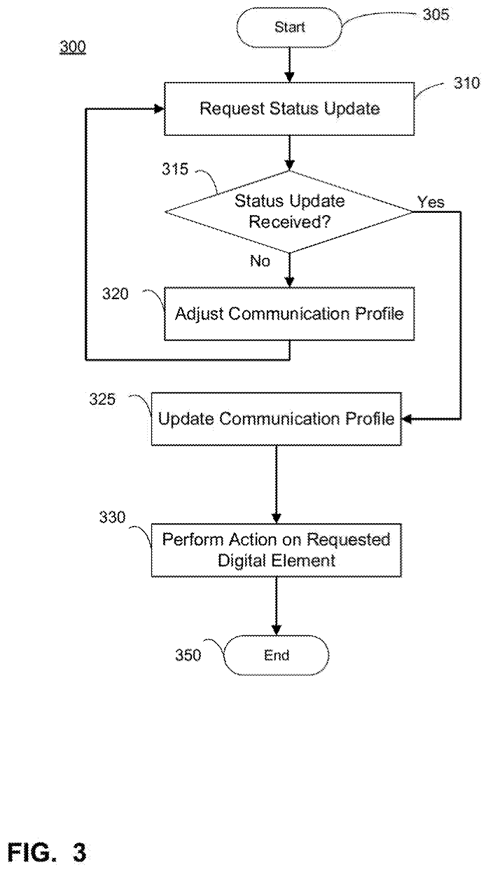

FIG. 3 is a flowchart of an example method 300 for communication profiles. Although execution of method 300 is described below with reference to computing device 210, other suitable components for execution of method 300 may be used.

Method 300 may begin at stage 305 and advance'to stage 310 where, device 210 may request a status update from a device according to a communication profile. In some implementations, device 210 may request the status update from each of a plurality of devices, wherein each of the plurality of devices is associated with a respective communication profile. For example, status monitor 110 may request a status update from device 120(A) and/or any and/or all o devices 120(A)-(D) according to respective communication profiles 140(A)-(D).

In some implementations, the communication profile may be shared among a plurality of devices. For example, device 120(B) may determine that an alternate DNS server provides needed information after a primary DNS server becomes unavailable. Device 120(B) may propagate its communication profile 140(B) to the other devices 120(C)-(D) on the same network to enable those devices 120(C)-(D) to update their respective communication profiles 140(C)-(D).

Method 300 may then advance to stage 315 where computing device 210 may determine whether the status update was received. For example, a communication between device 120(A) and status monitor 110 may comprise data errors, such as may be caused by dropped packets. For another example, device 210 may, acting as status monitor 110, request a status update from device 120(A) that is never received.

In response to determining that the status update was not received due to a communication failure, method 300 may advance to stage 320 where computing device 210 may adjust a parameter in the communication profile. The parameter may comprise, for example, a device hostname, a device address, a Dynamic Host Configuration Protocol (DHCP) parameter, a Domain Name Service (DNS) parameter, a communication protocol, a timeout value, a retry count, a retry interval, a network type, a packet size, and a time,

Method 300 may then return to stage 310 where computing device 210 may re-request the first status update from the device according to the communication profile comprising the adjusted parameter. For example, after updating the packet size parameter of communication profile 140(B), status monitor 110 may re-request a status update from device 120(B).

From stage 310, method 300 may again advance'to stage 315 where computing device 210 may determine whether the re-requested status update was received. In some implementations, method 300 may re-iterate through stages 310, 315, and 320, adjusting the communication parameters until the status update is received and/or the operation times out. In some implementations, the timeout of the operation may result in a determination that the status update was not received due to a failure of the device from which the status update was requested, and device 210 may report that device as out of service.

In response to determining that the re-requested status update was received at stage 315, method 300 may advance to stage 325 where device 210 may update the communication profile according to the adjusted parameter for a future status request from the device. For example, update communication profile instructions 230 may, in response to determining that the communication problem occurred from the first device, update the communication profile for the first device. In some implementations, the first device (e.g., device 120(A)) may determine that the communication problem occurred trying to communicate with status monitor 110. Device 120(A) may begin attempting to adjust communication parameters to achieve a successful communication. For example, different protocols (e.g., SNMP vs HTTP) may be tried, different commands within the protocol (e.g., HTTP PUT instead of HTTP POST commands) may be tried, different port numbers may be attempted, and/or different packet sizes and/or different retry attempt counts may be tried.

In some implementations, suggested parameters may be provided by status monitor 110 and/or device 210. In some implementations, the communicating device may examine previous communication attempts and try parameters that have worked in the past. For example, device 120(A) may attempt to provide a status report to device 210 at 9:00 am and fail. Device 120(A) may examine the communication profile 140(A) and determine that only communications occurring between 5:00 pm and 7:00 am have been successful. Device 120(A) may then update communication profile 140(A) to only attempt communication between those times, and retry the communication to provide the status report later during that time window.

In some implementations, update communication profile instructions 230 may comprise instructions to provide the updated communication profile to the device. For example, status monitor 110 may determine that SNMP responses result in a faster status update from device 120(B) than responses provided via HTTP. Respective communication profile 140(B) for device 120(B) may then be updated to communicate with status monitor 110 via SNMP for future status updates. Such an update may be in the form of a new and/or updated profile received from status monitor 110 and/or in the form of instructions from status monitor 110 for device 120(B) to perform the updates to communication profile 140(B). In some implementations, devices may share a communication profile. For example, devices 120(B)-(D) may be located on the same network, and may exchange details about their respective communication profiles 140(B)-(D). For example, device 120(B) may determine that an alternate DNS server provides needed information after a primary DNS server becomes unavailable. Device 120(B) may propagate its communication profile 140(B) to the other devices 120(C)-(D) on the same network to enable those devices 120(C)-(D) to update their respective communication profiles 140(C)-(D).

Method 300 may then advance to stage 315 where computing device 210 may report a status of the device according to the status update. For example, computing device 210 may provide a user interface displaying the supply level status of each of devices 120(A)-(D). Upon receiving status updates from any and/or each of devices 120(A)-(D), device 210 may update the user interface element associated with the appropriate device 120(A)-(D) according to the newly received status information comprising a current supply level.

Method 300 may then end at stage 350.

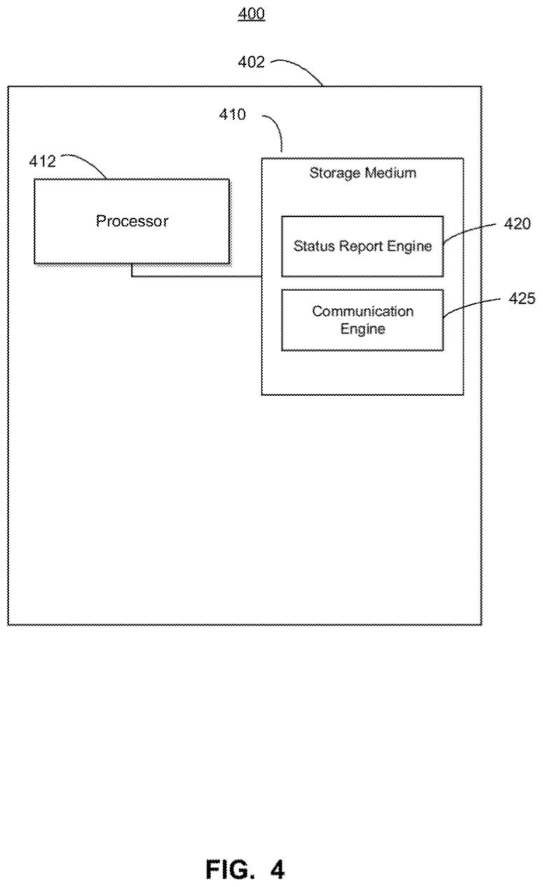

FIG. 4 is a block diagram of an example apparatus 400 for providing communication profiles. Apparatus 400 may comprise a computing device 402 comprising a storage medium 410, and a processor 412. Device 402 may comprise and/or be associated with, for example, a general and/or special purpose computer, server, mainframe, desktop, laptop, tablet, smart phone, game console, printer, multi-function device, and/or any other system capable of providing computing capability consistent with providing the implementations described herein. Device 402 may store, in storage medium 410, a status report engine 420 and a communication engine 425.

Each of engines 420, 425 may comprise any combination of hardware and programming to implement the functionalities of the respective engine. In examples described herein, such combinations of hardware and programming may be implemented in a number of different ways. For example, the programming for the engines may, be processor executable instructions stored on a non-transitory machine-readable storage medium and the hardware for the engines may include a processing resource to execute those instructions. In such examples, the machine-readable storage medium may store instructions that, when executed by the processing resource, implement engines 420, 425. In such examples, device 402 may comprise the machine-readable storage medium storing the instructions and the processing resource to execute the instructions, or the machine-readable storage medium may be separate but accessible to apparatus 400 and the processing resource.

Status report engine 420 may request a status report from a device according to a communication protocol and provide a device report to a user based on the status report from the device. For example, engine 420 may operate on status monitor 110 and may request a current supply level status report from each of devices 120(A)-(D).

Communication engine 425 may determine whether the requested status report was not received from the device. For example, engine 425 may comprise a list of all devices from which status reports were requested and may determine that a report from device 120(D), as an example, was not received and/or that the report comprised corrupted data.

In response to determining that the requested status report was not received from the device, communication engine 425 may modify a parameter of a communication profile associated with the device, cause the status report engine 420 to re-request the status report from the device according to the communication profile comprising the modified parameter, and determine whether the re-requested status report was received from the device. For example, status report engine 420 may have attempted to request the status report from device 120(D) via the HTTP protocol but received no response. Communication engine 425 may modify the protocol parameter of the communication profile 140(D) and re-request the status report via the SNMP protocol.

In response to determining that the re-requested status report was received from the device, communication engine 426 may request a subsequent status report according to the communication profile comprising the modified parameter. For example, if the status report from device 120(D) was successfully received via the newly attempted SNMP protocol, profile 140(D) may be updated such that subsequent stat reports from device 120(D) are also requested via the SNMP protocol.

In the foregoing detailed description of the disclosure, reference is made to the accompanying drawings that form a part hereof, and in which is shown by way of illustration how examples of the disclosure may be practiced. These examples are described in sufficient detail to allow those of ordinary skill in the art to practice the examples of this disclosure, and it is to be understood that other examples may be utilized and that process, electrical, and/or structural changes may be made without departing from the scope of the present disclosure.

What is claimed is:

1. A non-transitory machine readable medium storing instructions executable by a processor to:
receive a first status update from a device according to a communication profile;
determine whether a communication problem occurred from the device;
in response to determining that the communication problem occurred from the first device, update the communication profile for the first device; and
receive a second status update from the device according to the updated communication profile.

2. The non-transitory machine readable medium of claim 1. wherein the communication profile comprises a plurality of parameters associated with a network-based communication.

3. The non-transitory machine readable medium of claim 2, wherein a parameter of the plurality of parameters comprises a communication interval.

4. The non-transitory machine readable medium of claim 2, wherein a parameter pf the plurality of parameters comprises a communication protocol.

5. The non-transitory machine readable medium of claim 2, wherein, a parameter of the plurality of parameters comprises a domain name service (DNS) parameter.

6. The non-transitory machine readable medium of claim 1, wherein the instructions to receive the first status update from the device comprise instructions to receive a plurality of respective status updates from a plurality of devices.

7. The non-transitory machine readable medium of claim 3, wherein each of the plurality of devices is associated with a respective communication profile,

8. The non-transitory machine readable medium of claim 1, wherein the instructions to update the communication profile for the first device comprise instructions to provide the updated communication profile to the device.

9. The non-transitory machine readable medium of claim 1, wherein the first status update and the second status update each comprise a device identifier.

10. A method comprising:
requesting a status update from a device according to a communication profile;
determining whether the status update was received;
in response to determining that the status update was not received due to a communication failure:
adjusting a parameter in the communication profile,
re-requesting the first status update from the device according to the communication profile comprising the adjusted parameter,
determining whether the re-requested status update was received, and
in response to determining that the re-requested status update was received, updating the communication profile according to the adjusted parameter for a future status request from the device; and
reporting a status of the device according to the status update.

11. The method of claim 10, wherein the parameter comprises at least one of the following: a device hostname, a device address, a Dynamic Host Configuration Protocol (DHCP) parameter, a Domain Name Service (DNS) parameter, a communication protocol, a timeout value, a retry count, a retry interval, a network type, a packet size, and a time.

12. The method of claim 10, wherein the communication profile is shared among a plurality of devices.

13. The method of claim 10, further comprising requesting the status update from each of a plurality of devices, wherein each of the plurality of devices is associated with a respective communication profile.

14. The method of claim 10, further comprising: in response to determining that the first status update was not received due to a failure of the device, reporting the device as out of service.

15. A system, comprising:
a status report engine to:
request a status report from a device according to a communication protocol, and
provide a device report to a user based on the status report from the device; and
a communication engine to:
determine whether the requested status report not received from the device, and
in response to determining that the requested status repo was not eceived from the device:
modify a parameter of a communication profile associated with the device;
cause the status report engine to re-request the status report from the device according to the communication profile comprising the modified parameter;
determine whether the re-requested status report was eceived from the device; and
in response to determining that the re-requested status report was received from the device, request a subsequent status report according to the communication profile comprising the modified parameter.
